(19) United States
(12) Patent Application Publication
(10) Pub. No.: US 2022/0156837 A1
(43) Pub. Date: May 19, 2022

(54) DISTRIBUTED LEDGER IMPLEMENTATION FOR ENTITY FORMATION AND MONITORING SYSTEM

(71) Applicant: ZenBusiness PBC, Austin, TX (US)

(72) Inventors: Muhammad Ashar Malik, Austin, TX (US); Rafael Lopez, Austin, TX (US); Van Phuong Phu, Tucson, AZ (US)

(73) Assignee: ZenBusiness PBC, Austin, TX (US)

(21) Appl. No.: 17/665,328

(22) Filed: Feb. 4, 2022

Related U.S. Application Data
(63) Continuation of application No. 16/669,077, filed on Oct. 30, 2019.
(60) Provisional application No. 62/752,941, filed on Oct. 30, 2018.

(51) Int. Cl. G06Q 40/04; H04L 9/32; G06Q 20/36; H04L 9/06

(52) U.S. Cl. CPC G06Q 40/04; H04L 9/0637; G06Q 20/3674; H04L 9/3255

(57) ABSTRACT

A system for operating a distributed ledger implementation for tracking and monitoring entity shares involves receiving a share configuration control at an entity formation and management system by way of a user interface. The system configures a distributed ledger comprising a plurality of gateway nodes to record share transfer activity comprising entity share distribution between the entity, the user account, and combinations thereof in a blockchain as entity records. The system communicates with an oracle service, information provided by the share configuration control, to verify share transfer requirements for each entity share distribution. The system transfers entity shares to the first party in response to the oracle service verifying that the share transfer requirements were met by the first party and the entity. The system writes a share transfer record into the blockchain in response to the oracle service verifying that the share transfer requirements were met.

### CROSS-REFERENCE TO RELATED APPLICATIONS

This application claims the benefit of U.S. provisional patent application serial no. 62/752,941, filed on Oct. 30, 2018, the contents of which are incorporated herein by reference in their entirety.

### BACKGROUND

Monitoring the transfer of shares between an entity (e.g., business entity (e.g., LLC, Inc., etc.,) and individuals (e.g., employee, investor, etc.,) requires the maintenance and tracking of a plurality of contracts with each individual contract having their own specific requirements (e.g., vesting period, earning requirements, etc.,) that need to be validated before the transfer is completed. Existing systems require the entity to monitor the contracts and update the number of shares that can potentially result in inaccuracies without regular auditing. Therefore, a need exists for a system that is able to update and track the transfer of shares according to the conditions written into their contracts.

### BRIEF SUMMARY

A method of operating a distributed ledger implementation for tracking and monitoring entity shares involves receiving a share configuration control at an entity formation and management system by way of a user interface. The entity formation and management system may include information about an entity's share structure. The share configuration control may be a request by a first party with a user account to change the share structure of the entity.

The method may configure a distributed ledger comprising a plurality of gateway nodes to record share transfer activity comprising entity share distribution between the entity, the user account, and combinations thereof in a blockchain as entity records. In the method, the distributed ledger may include entity digital assets representing entity shares. The method communicates with an oracle service, information provided by the share configuration control, to verify share transfer requirements for each entity share distribution.

The method may involve transferring entity shares to the first party in response to the oracle service verifying that the share transfer requirements were met by the first party and the entity. The method may write a share transfer record into the blockchain in response to the oracle service verifying that the share transfer requirements were met by the first party and the entity.

A non-transitory computer-readable storage medium, the computer-readable storage medium including instructions that when executed by a computer, cause the computer to receive a share configuration control at an entity formation and management system by way of a user interface. The entity formation and management system may include information about an entity's share structure, and where the share configuration control may be a request by a first party with a user account to change the share structure of the entity.

The instructions may cause the computer to configure a distributed ledger comprising a plurality of gateway nodes to record share transfer activity comprising entity share distribution between the entity, the user account, and combinations thereof in a blockchain as entity records, wherein the distributed ledger includes entity digital assets representing entity shares. The instructions may cause the computer to communicate with an oracle service, information provided by the share configuration control, to verify share transfer requirements for each entity share distribution. The instructions may cause the computer to transfer entity shares to the first party in response to the oracle service verifying that the share transfer requirements were met by the first party and the entity. The instructions may cause the computer to write a share transfer record into the blockchain in response to the oracle service verifying that the share transfer requirements were met by the first party and the entity.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an entity formation and management system 100 in accordance with one embodiment.

FIG. 2 illustrates a share tracking system 200 in accordance with one embodiment.

FIG. 3 illustrates a method 300 in accordance with one embodiment.

FIG. 4 illustrates a share tracking system 400 in accordance with one embodiment.

FIG. 5 illustrates a share tracking system 500 in accordance with one embodiment.

FIG. 6 illustrates a share tracking system 600 in accordance with one embodiment.

FIG. 7 illustrates a share tracking system 700 in accordance with one embodiment.

FIG. 8 illustrates a share tracking system 800 in accordance with one embodiment.

FIG. 9 illustrates a share tracking system 900 in accordance with one embodiment.

FIG. 10 illustrates a blockchain transaction process 1000 in accordance with one embodiment.

FIG. 11 illustrates a blockchain formation 1100 in accordance with one embodiment.

FIG. 12 illustrates a blockchain 1200 in accordance with one embodiment.

FIG. 13 illustrates a system 1300 in accordance with one embodiment.

FIG. 14 depicts an illustrative computer system architecture 1400 that may be used in accordance with one or more illustrative aspects described herein.

### DETAILED DESCRIPTION

“(BA)-keypair” refers to a “board authority” keypair assigned to a member of the board authority for casting a vote for approving, rejecting, or confirming share transfer transactions between the entity and a user account or between user accounts.

“(FP)-keypair” refers to a “first party” keypair assigned to a member of the entity, or someone seeking to become a member of the entity, for casting a vote for approving, rejecting, or confirming share transfer transactions between the entity and a user account or between user accounts.

“2-of-3 multisignature wallet” refers to requiring at least two keys out of 3 to authorize a digital asset transaction. Crypto wallets are digital and physical, offline and online methods that rely on public key cryptography to allow users to send and receive digital assets securely across a network.

“Accidental fork” refers to a branching in the chain that happens when two or more miners find a block at nearly the same time. The fork is resolved when subsequent block(s) are added and one of the chains becomes longer than the alternative(s). The network abandons the blocks that are not in the longest chain (they are called orphaned blocks).

“Block submission service” refers to a service for writing share transfer records to the blockchain of the distributed ledger following approval of a share transfer transaction

“Block time” refers to the average time it takes for the network to generate one extra block in the blockchain.

“Blockchain” refers to is a growing list of records, called blocks, that are linked using cryptography. Each block contains a cryptographic hash of the previous block, a timestamp, and transaction data (generally represented as a Merkle tree).

By design, a blockchain is resistant to modification of the data. It is an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Blockchains may be considered secure by design and exemplify a distributed computing system with high Byzantine fault tolerance. Decentralized consensus has therefore been claimed with a blockchain.

“Board authority” refers to a board of directors including officers and board members that takes action collectively and is responsible for the governance of a company. The board of directors must delegate responsibilities to individual officers and board members, as none are authorized to act on their own.

“Board member” refers to a member of the board of directors.

“Digital assets” refers to a digital representation of something of value, for which ownership is verified and recorded on a distributed ledger. Digital assets may be cryptocurrencies, crypto assets, virtual currencies, and crypto tokens. Some represent stakes in a particular project or company. Others are intended to be currencies, like Bitcoin, and do not represent a stake in a particular organization.

“Entity keypair” refers to Keypair given to the Officers and Shareholders of the entity. The shareholders may have different voting rights, while officers may have the same voting rights. The Officers may appoint managers to approve transfers with votes submitted by the keypair.

“Entity share distribution” refers to distribution of ownership rights of the entity among eligible parties. For example, investors may be assigned a certain number of shares granting them ownership rights to the company in exchange for a monetary investment in the company.

“Entity shares” refers to ownership rights of the entity distributable to eligible parties.

“Existing entity shares” refers to current pool of ownership right for a company

“Fork” refers to what happens when a blockchain diverges into two potential paths forward.

“Hard fork” refers to a rule change such that the software validating blocks according to the old rules will detect the blocks produced according to the new rules as invalid.

“M-keypairs” refers to total number of keypairs utilized in a keypair voting authentication scheme.

“Multisignature wallet” refers to for example, the request from a multisignature wallet would be similar to “function submit Transaction(address destination, unit value, bytes data)”

“N-keypairs” refers to number of keypairs required in a keypair authentication scheme to approve a transaction.

“New digital assets” refers to tokenized shares transferable between parties representing a new distribution of an entity's ownership rights.

“New entity shares” refers to unissued ownership rights for an entity transferable to eligible participants.

“Oracle service” refers to a third party application service monitoring smart contracts written into the creation of a block in a blockchain. The oracle service may interface with other applications through an application program interface to monitor the conditions of a smart contract and report the results to the ledger as a source of truth. CARTA, LLC is an example of an oracle service, but is not limited thereto.

“Orphaned blocks” refers to blocks in an abandoned fork.

“Private blockchain” refers to (i.e., permissioned blockchains) blockchains that use an access control layer to govern who has access to the network. In contrast to public blockchain networks, validators on private blockchain networks are vetted by the network owner. They do not rely on anonymous nodes to validate transactions nor do they benefit from the network effect. Private blockchains can also go by the name of ‘consortium’ or ‘hybrid’ blockchains.

“Share configuration control” refers to control signal communicated to participants that alters the structure of an entity's share distribution or pool of available shares.

“Share transfer record” refers to transactional record recording movement of shares between eligible parties written to the blockchain of a distributed ledger.

“Smart contract” refers to smart contracts are contracts that can be partially or fully executed or enforced without human interaction. One of the main objectives of a smart contract is automated escrow. The IMF believes smart contracts based on blockchain technology could reduce moral hazards and optimize the use of contracts in general. Due to the lack of widespread use their legal status is unclear. A blockchain implementation that enables the coding of contracts that execute when specified conditions are met. A blockchain smart contract is enabled by logic that defines and executes an agreement. For example, Ethereum Solidity is an open-source blockchain project that was built specifically to realize this possibility by implementing a Turing-complete programming language capability to implement smart contracts.

“Soft fork” refers to a change of rules that creates blocks recognized as valid by the old software, i.e. it is backwards-compatible.

“SOS” refers to secretary of state.

“Weighted keypair” refers to a scenario where combinations of the number of keypairs (N) and the total number of keypairs (M) have been modified so that a larger percentage of the M is given to board and/or entity shareholders. N represents the number of keypairs required for vote authentication of a transaction and the M represents the total keypairs in the authentication scheme.

The disclosure is directed to a method, a system, and a computer-readable medium related to operating a distributed ledger implementation for tracking and monitoring entity shares. The method involves receiving a share configuration control at an entity formation and management system by way of a user interface. In the method the entity formation and management system may include information about an entity's share structure. In the method, the share configuration control may be a request by a first party with a user account to change the share structure of the entity.

The method may configure a distributed ledger comprising a plurality of gateway nodes to record share transfer activity comprising entity share distribution between the entity, the user account, and combinations thereof in a blockchain as entity records. In the method, the distributed ledger may include entity digital assets representing entity shares. The method communicates with an oracle service, information provided by the share configuration control, to verify share transfer requirements for each entity share distribution.

The method may involve transferring entity shares to the first party in response to the oracle service verifying that the share transfer requirements were met by the first party and the entity. The method may write a share transfer record into the blockchain in response to the oracle service verifying that the share transfer requirements were met by the first party and the entity.

The method may configure a distributed ledger comprising a plurality of gateway nodes to record share transfer activity comprising entity share distribution between the entity, the user account, and combinations thereof in a blockchain as entity records. The distributed ledger may include entity digital assets representing entity shares.

The method may interface with an oracle service, configured by the share configuration control, to verify share transfer requirements for each entity share distribution.

The method may transfer entity shares to the first party in response to the oracle service verifying that the share transfer requirements were met by the first party and the entity. The method may write a share transfer record into the blockchain in response to the oracle service verifying that the share transfer requirements were met by the first party and the entity.

In some configurations, the request to change the structure of the entity is at least one of transferring existing entity shares to an existing shareholder, transferring the existing entity shares to a new shareholder, transferring new entity shares to an existing shareholder, and transferring the new entity shares to a new shareholder.

In some configurations, the first party and the entity may be granted a multisignature wallet configured to accept keypairs, wherein the multisignature wallet requires approval from N-keypairs out of M-keypairs to transfer the entity shares to the first party and write the share transfer record into the distributed ledger by way of a block submission service.

In some configurations, the first party may be granted X first party (FP)-keypairs out of M-keypairs. The entity may be granted Y entity-keypairs out of M-keypairs. The board authority may be granted Z board authority (BA)-keypairs out of M-keypairs. In this configuration a total number of M-keypairs equals X+Y+Z, and the board authority is part of the entity.

In some configurations, the N-keypairs may include at least one entity-keypair and at least one BA-keypair. In other configurations, the N-keypairs may not include any FP-keypairs.

In some configurations of the method, the transferring of new issuance entity shares may include granting the first party and the entity a multisignature wallet configured to accept keypairs, wherein the multisignature wallet requires approval from N-keypairs out of M-keypairs to transfer the entity shares or new issuance entity shares to the first party, or write the share transfer record into the blockchain. The method may fill a new share multisignature wallet with new digital assets. The method may then transfer the new digital assets to the first party. The new digital assets in the new share multisignature wallet may be utilized to transfer the new issuance entity shares from the new share multisignature wallet to the first party multisignature wallet. The number of new digital assets in the new share multisignature wallet may be reduced by the number of new entity shares transferred.

In some configurations, the entity digital assets may be updated in the distributed ledger to reflect the new share distribution.

In some configurations, the new digital assets may not be part of the entity digital assets in the distributed ledger.

A non-transitory computer-readable storage medium, the computer-readable storage medium including instructions that when executed by a computer, cause the computer to receive a share configuration control at an entity formation and management system by way of a user interface. The entity formation and management system may include information about an entity's share structure, and where the share configuration control may be a request by a first party with a user account to change the share structure of the entity. The instructions may cause the computer to configure a distributed ledger comprising a plurality of gateway nodes to record share transfer activity comprising entity share distribution between the entity, the user account, and combinations thereof in a blockchain as entity records, wherein the distributed ledger includes entity digital assets representing entity shares. The instructions may cause the computer to communicate with an oracle service, information provided by the share configuration control, to verify share transfer requirements for each entity share distribution. The instructions may cause the computer to transfer entity shares to the first party in response to the oracle service verifying that the share transfer requirements were met by the first party and the entity. The instructions may cause the computer to write a share transfer record into the blockchain in response to the oracle service verifying that the share transfer requirements were met by the first party and the entity.

In some configurations, the request to change the structure of the entity is at least one of transfer existing entity shares to an existing shareholder, transferring the existing entity shares to a new shareholder, transferring new entity shares to an existing shareholder, and transferring the new entity shares to a new shareholder.

In some configurations, the instructions further configure the computer to grant the first party and the entity a multisignature wallet configured to accept keypairs, wherein the multisignature wallet requires approval from N-keypairs out of M-keypairs to transfer the entity shares to the first party and write the share transfer record into the distributed ledger by way of a block submission service.

In some configurations, the first party may be granted X first party (FP)-keypairs out of M-keypairs. The entity is granted Y entity-keypairs out of M-keypairs. The board authority may be granted Z board authority (BA)-keypairs out of M-keypairs. The total number of M-keypairs may equal X+Y+Z, and the board authority may be part of the entity. In other configurations, the N-keypairs may include at least one entity-keypair and at least one BA-keypair. In other configurations, the N-keypairs may not include any FP-keypairs.

In some configurations, the instructions may further configure the computer to transfer new issuance entity shares involving granting the first party and the entity a multisignature wallet configured to accept keypairs, wherein the multisignature wallet requires approval from N-keypairs out of M-keypairs to transfer the entity shares or new issuance entity shares to the first party, or write the share transfer record into the blockchain. The instructions may configure the computer to fill a new share multisignature wallet with new digital assets. The instructions may configure the computer to transfer the new digital assets to the first party. The new digital assets in the new share multisignature wallet may be used to transfer the new issuance entity shares from the new share multisignature wallet to the first party multisignature wallet. The number of new digital assets in the new share multisignature wallet is reduced by the number of new entity shares transferred. In some configurations, the instructions further configure the computer to update the entity digital assets in the distributed ledger to reflect the new share distribution. In other configurations, the new digital assets may not be part of the entity digital assets in the distributed ledger.

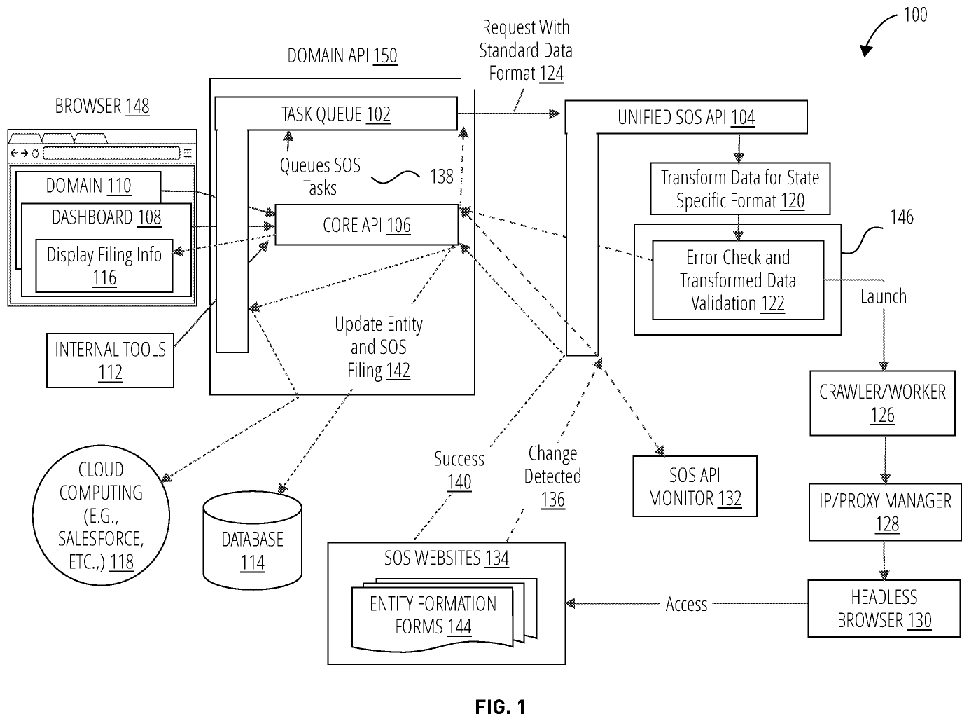

Referencing FIG. 1, an entity formation and management system 100 comprises a browser 148, an internal tools 112, a database 114, a domain API 150, a unified SOS API 104, an SOS API monitor 132, a crawler/worker 126, an IP/proxy manager 128, and a headless browser 130. The browser 148 displays a domain 110 hosting the entity formation and management system 100 and a dashboard 108 for configuring and monitoring services associated with the entity formation and management system 100. The domain 110 and the dashboard 108 communicate with the domain API 150. The domain API 150 receives controls from the domain 110, the dashboard 108, and internal tools 112. The domain API 150 comprises a task queue 102 and a core API 106. Configuration controls from the domain 110, the dashboard 108 and the internal tools 112 come through the domain API 150 to a core API 106. The dashboard 108 may also display filing info 116 one the information has been submitted.

When the entity formation and management system 100 is assisting a user from their business entity, the configuration controls (e.g., form data for filling out the entity formation form) from the domain 110 and the dashboard 108 are communicated to the core API 106 which then communicates the controls to the task queue 102 which queues SOS tasks 138. The secretary of state (SOS) tasks are tasks associated with the formation and management of an entity (e.g., business entity (LLC, INC, etc.)). The task queue 102 then sends a request with standard data format 124 to a unified SOS API 104. The unified SOS API 104 transform data for state specific format 120 required by the SOS form for the formation of the business entity and validates the information in the data through operation of a validator 146. In some configurations, outputs from the domain API 150 may be communicated to a cloud computing system 118 to perform further processing.

The validator 146 performs an error check and transformed data validation 122, to check that there are not data errors, such as there being insufficient data for filing the entity formation form in that particular state, as well as checking that all state requirements (i.e. board approval, additional, customer action) have been met by the applicant (i.e., user). When the validator is completed, the unified SOS API 104 launches a crawler/worker 126, an IP/proxy manager 128, a headless browser 130 to access the specific secretary of state SOS websites 134. The IP/proxy manager 128 provides IP rotation and proxy management services to circumvent IP block lists associated with accessing particular SOS websites 134. The headless browser 130 provides a command line interface for accessing the SOS websites 134 reducing the resource requirements associated with access the SOS websites 134 on a user's computer. After successfully retrieving the forms, the system may update entity and SOS filing 142 in the database 114.

The SOS websites 134 comprises entity formation forms 144 that the crawler/worker 126 and the headless browser 130 are able to fill out and submit the entity formation forms 144 with the user provided form fill data. Depending on the success of the submission, the system may respond back to the unified SOS API 104 with a success control 140 or a change detected control 136.

The communication of the success control 140 to the unified SOS API 104

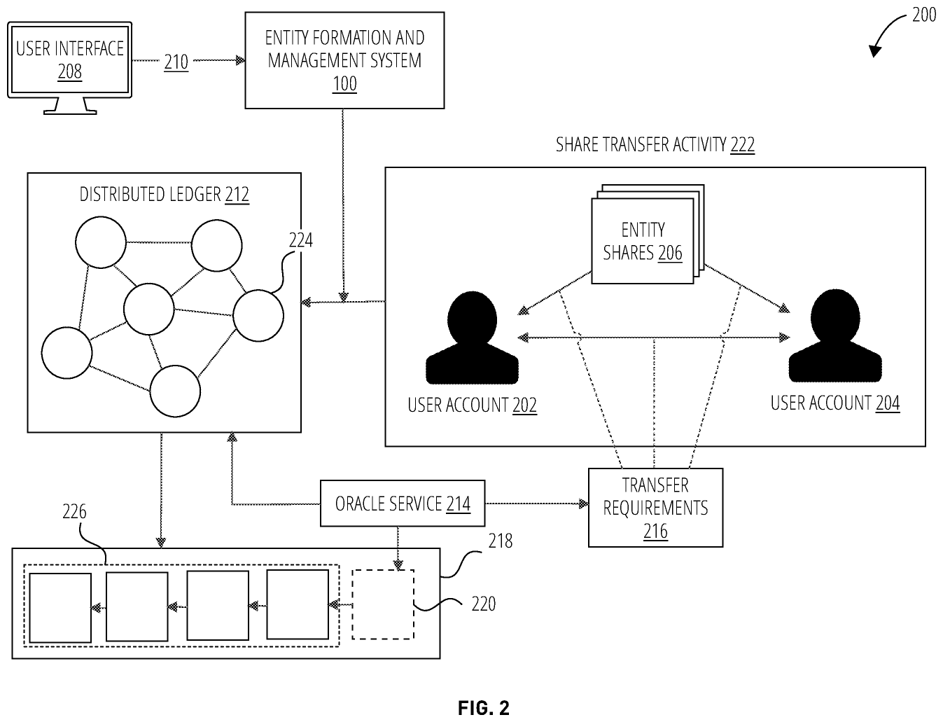

Referencing FIG. 2, a share tracking system 200 includes a user interface 208, an entity formation and management system 100, and a distributed ledger 212. The user interface 208 configures an entity formation and management system 100 with a share configuration control 210 to track share transfer activity 222 comprising entity shares 206 being transferred between the entity (e.g., business entity, LLC, INC, etc.,) between, user accounts (e.g., employees(user account 202, user account 204)), and combinations thereof. The entity formation and management system 100 records the share transfer activity 222 in a distributed ledger 212 comprising a plurality of interconnected gateway nodes 224 each comprising a record of a blockchain 218 comprising entity records 226. The entity formation and management system 100 may communicate with an oracle service 214 as a third party service to validate that share transfer requirements 216 have been met before a share transfer record 220 is written to the blockchain 218 as entity records 226 for the particular entity. In some configurations, the share transfer requirements 216 may be equivalent to a smart contract.

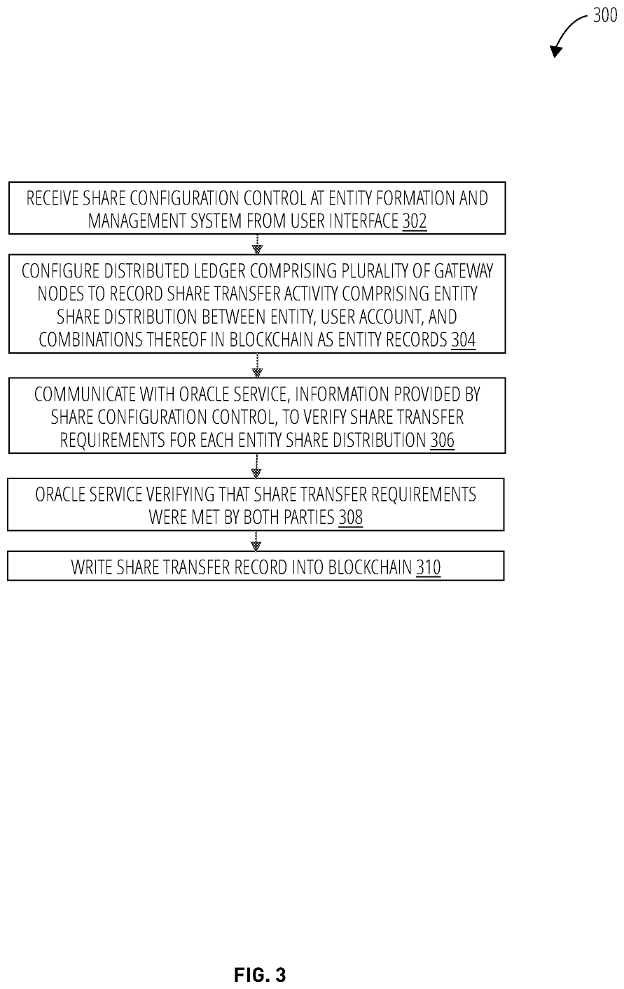

The share tracking system 200 may be operated in accordance with the process described in FIG. 3.

Referencing FIG. 3, In block 302, method 300 receives a share configuration control at an entity formation and management system from a user interface. In block 304, method 300 configures a distributed ledger comprising a plurality of gateway nodes to record share transfer activity comprising entity share distribution between an entity, a user account, and combinations thereof in a blockchain as entity records. In block 306, method 300 communicates with an oracle service, information provided by the share configuration control, to verify share transfer requirements for each entity share distribution. In block 308, the method 300 communicates with the oracle service verifying that the share transfer requirements were met by both parties. In block 310, method 300 writes a share transfer record into the blockchain.

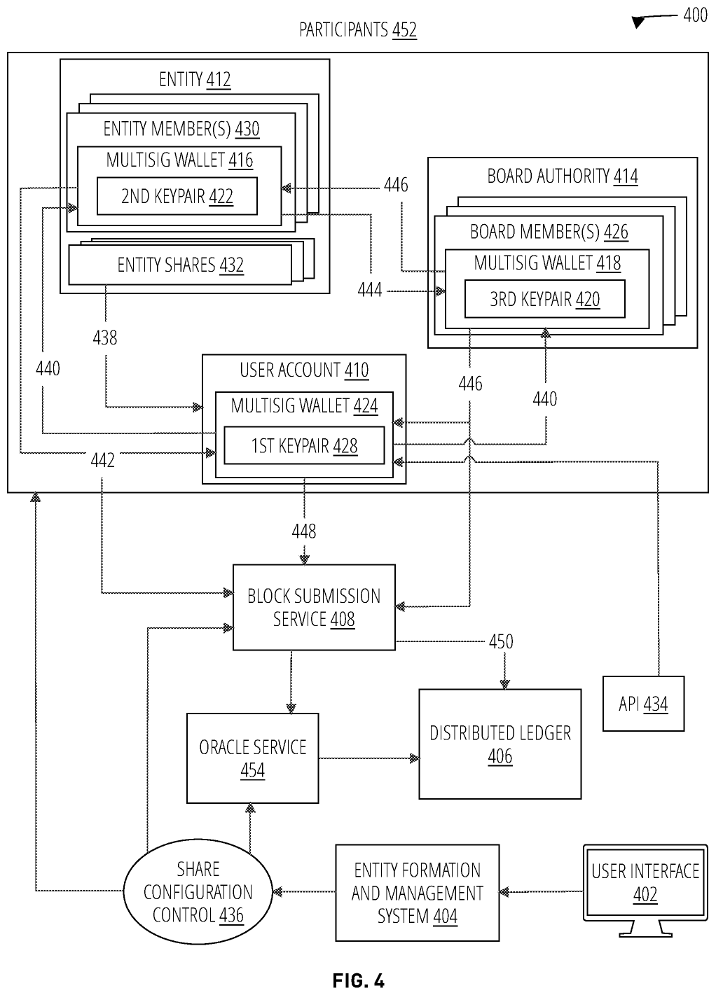

FIG. 4, illustrates a share tracking system 400 in accordance with one embodiment. The share tracking system 400 comprises a user interface 402, an entity formation and management system 404, a distributed ledger 406, a block submission service 408, an oracle service 454, and participants 452. The entity formation and management system 404 receives a request from a user interface 402 to make a change to the entity. The entity formation and management system 404 includes information about an entity's share structure. The share configuration control 436 is a request to change the share structure of the entity associated with the entity formation and management system 404. In the share tracking system 400, the share configuration control 436 is a share transfer request between a first party (user account 410) and the entity 412.

The share configuration control 436 is communicated to participants 452 of the share transfer request that includes an entity 412, a board authority 414, and a first party (user account 410). Each participant includes a multisignature wallet to verify, confirm, or dispute share transfer activity through voting rights associated with a set of keypairs.

The multisignature wallets may be configured as a 2/3 voting right multisignature wallet with a first keypair given to the user account 410, a second keypair given to the entity 412, and a third key pair given to the board authority 414. The keypairs may be utilized to confirm the identity of the voting members and as votes confirming the transfer of shares between the entity and a user account as well as between different user accounts.

In some configurations, the entity 412 may create multiple wallets designed for different voting rights.

The user account 410 may be associated with a multisignature wallet 424 comprising a first party keypair 428 that was generated through an application programming interface (API 434) for the user account 410. The API 434 may be utilized to restrict the creation of multisignature wallets and limit participants in the share tracking system.

The entity 412 comprise a multisignature wallet 416 with an entity keypair 422 that may be operated by at least one entity member 430. The entity member 430 may represent the officers and/or shareholders of the formed entity responsible for the entity shares 432. The entity 412 may operate with a board authority 414 comprising at least one board member 426 that may represent the board of directors, for the entity 412. The board member 426 may operate a multisignature wallet 418 with a board authority keypair 420 that may be utilized to submit a vote confirming or disputing share transfers between the entity 412 and the user account 410 or between user accounts.

In the share tracking system 400, the share configuration control 436 is a request from the user account 410 for entity shares 432. The multisignature wallet 424 of the user account 410 may communicate a transfer request 440 to the multisignature wallet 416 of entity 412 and the multisignature wallet 418 of the board authority 414. The at least one entity member 430 may accept the conditions of the share transfer and approve it through the entity keypair 422. The at least one entity member 430 may then communicate an approval request 444 to the board authority 414. The at least one board member 426 may respond to the approval request 444 with a confirmation 446 communicated to the multisignature wallet 416 and the multisignature wallet 424, of the entity 412 and the user account 410, respectively. After receiving the confirmation 446 the entity 412 may communicate a confirmation 442 to the multisignature wallet 424 of the user account 410.

The confirmation 446, confirmation 442, and a confirmation 448 from the multisignature wallet 424 of the user account 410 may then be communicated to a block submission service 408 to generate a share transfer record 450 to be included in the distributed ledger 406. Block submission service 408 may notify an oracle service 454 of the share transfer record 450, where the oracle service 454 determines if external conditions of the share transfer have been met by all parties before the share transfer record 450 is written to the distributed ledger 406. With the share transfer record 450 written into the distributed ledger 406, a share transfer 438 occurs moving the entity shares 432 to the user account 410. In some configurations, the share transfer 438 is documented in the distributed ledger 406 as a share transfer record 450 without physical transfer of digital assets between the entity 412 and the user account 410. The oracle service 454 may also write its verification to the distributed ledger 406 as a source of truth.

In some configurations, the distributed ledger 406 may be configured to operate distributed ledger technologies such as colored coins, RGB on Lightning Network, Ethereum, etc., but is not limited thereto.

In one scenario, a user may want to become a new shareholder. In this scenario, existing shares may be transferred to the user without the issuance of new shares. In this scenario, the user requests/pays for transferred shares and is granted a keypair (first keypair) to submit the share transfer request. The entity receives the request and approves the transaction utilizing its keypair (second keypair). The board authority then reviews the transfer request and approves or declines the request with its keypair (third keypair). In this situation, a transfer may be completed using two keypairs and one of those keypairs MAY be the first keypair.

In one scenario, a user may want to become a new shareholder and new shares may need to be issued. In this scenario, the user may request/pay for transferred shares and is granted a keypair (first keypair) to submit the share transfer request. The entity may approve the transaction utilizing its keypair (second keypair). The board authority may then submit approval if necessary to issue new shares utilizing its keypair (third keypair). In this situation, a transfer may be completed using two keypairs, but one of those keypairs MUST be the third keypair.

In one configuration, a user may want to become a new shareholder and may utilize an external event API. In this configuration, the user may request/pay for transferred shares and is granted a keypair (first keypair) to submit the share transfer request. The entity may approve the transaction utilizing its keypair (second keypair). In this case, the board authority may be required to approve the transaction before the shares are transferred utilizing its keypair (third keypair). In this scenario, a transfer may be completed only if the second keypair AND the third keypair approve.

In one scenario, a user may want to become a new shareholder and new shares may need to be issued, but the board authority has weighted keypairs. In this scenario, the user may request/pay for transferred shares and is granted a keypair (first keypair) to submit the share transfer request. The entity may approve the transaction utilizing its keypair (second keypair). The board authority's approval may then be necessary to issue new shares and board has multiple weighted keypairs with different voting shares. In this scenario, a transfer may be completed using two keypairs, but one of those keypairs may be the majority of the weighted keypairs.

Another scenario may involve a major stock purchase/ownership transfer that may result in a controlling position of the entity. In this scenario, the user may want to become a new shareholder and new shares need to be issued. The Board and entity Shareholders may also have weighted keypairs. The user may request/pay for transferred shares and is granted a keypair (first keypair) to submit the share transfer request. The entity may approve the transaction that includes the shareholders' weighted keypairs. The board authority's approval may then be necessary to issue new shares as the board has multiple weighted keypairs with different voting shares. In this scenario, a transfer may be completed using two keypairs and both of those keypairs MUST be the majority (Shareholder and BA) of the weighted keypair.

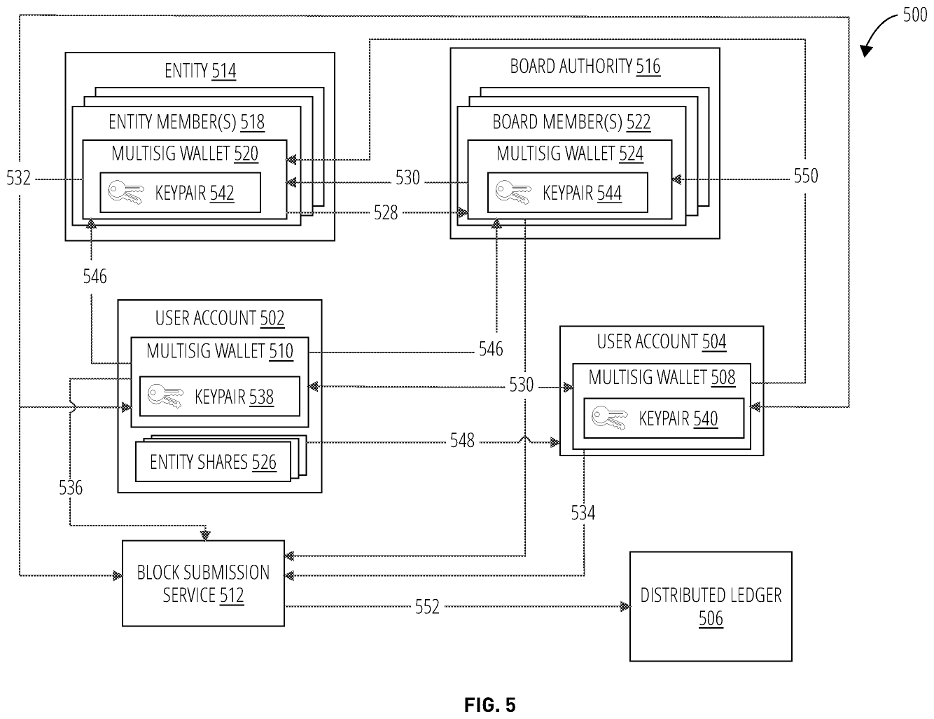

FIG. 5 illustrates a share tracking system 500 in accordance with one embodiment. The share tracking system 500 comprises a block submission service 512, a distributed ledger 506, an entity 514, a board authority 516, a user account 502, and a user account 504. In the share tracking system 500, a share configuration control was received for transferring entity shares 526 from the user account 502 to the user account 504. A user account 502, utilizing the multisignature wallet 510 with the keypair 538, declares via an API, a transfer request 546 to the multisignature wallets of the entity 514 and the board authority 516, multisignature wallet 520 and multisignature wallet 524, respectively. Similarly, the user account 504, utilizing the multisignature wallet 508 with the keypair 540, declares via the API, a transfer request 550 to the multisignature wallets of the entity 514 and the board authority 516, multisignature wallet 520 and multisignature wallet 524, respectively.

At least one entity member 518 of the entity 514 confirms and approves the transfer request 546 through utilizing the entity keypair 542 to sign off on the transaction 528 of the transfer request 546. The entity 514 may communicate a confirmation 532 to the owners of the multisignature wallets of the user account 502 and the user account 504, as well as the block submission service 512 following its vote.

At least one board member 522, depending on the configuration of the board authority 516, receives the transfer request 546. The at least one board member 522 may approve of the share transfer 548 between the user account 502 and the user account 504 by signing off on the transaction with their board authority keypair 544. The board authority 516 may communicate a confirmation 530 to the owners of the multisignature wallets of the entity 514, the user account 502, and the user account 504, as well as the block submission service 512.

The user account 502 and the user account 504 may communicate confirmations (confirmation 536 and confirmation 534) from their accounts to the block submission service 512 awaiting approval from the entity 514 and the board authority 516.

With sign offs received from all participants, the block submission service 512 writes a share transfer record 552 to the distributed ledger 506 indicating a share transfer 548 of entity shares 526 from the user account 502 to the user account 504.

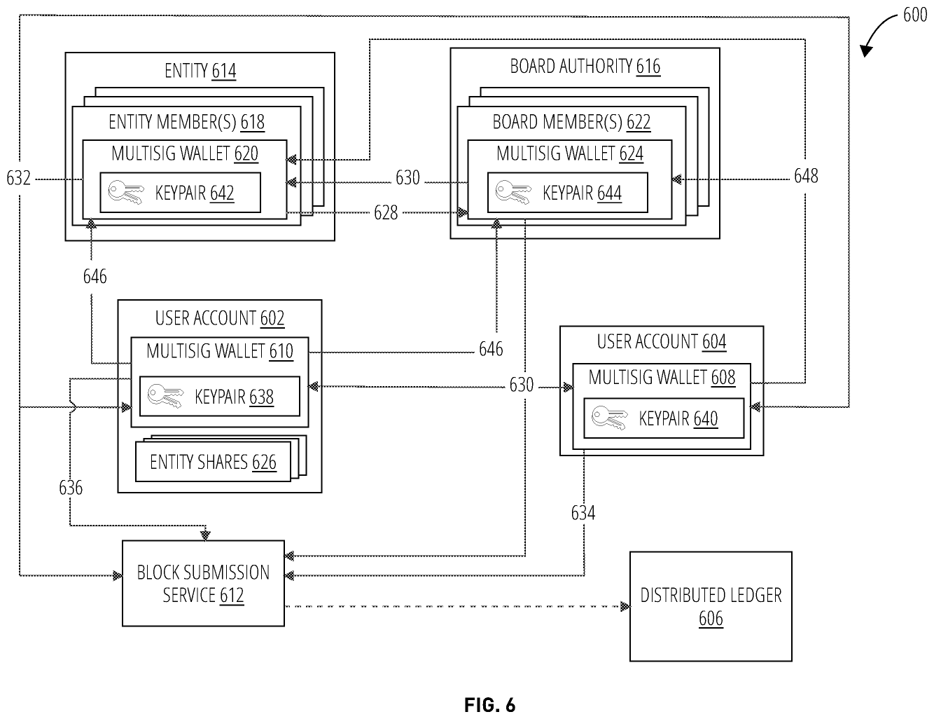

FIG. 6 illustrates a share tracking system 600 in accordance with one embodiment. The share tracking system 600 comprises a block submission service 612, a distributed ledger 606, an entity 614, a board authority 616, a user account 602, and a user account 604. In the share tracking system 600, a share configuration control was received for transferring entity shares 626 from the user account 602 to the user account 604. A user account 602, utilizing the multisignature wallet 610 with the keypair 638, declares via an API, a transfer request 646 to the multisignature wallets of the entity 614 and the board authority 616, multisignature wallet 620 and multisignature wallet 624, respectively. Similarly, the user account 604, utilizing the multisignature wallet 608 with the keypair 640, declares via the API, a transfer request 648 to the multisignature wallets of the entity 614 and the board authority 616, multisignature wallet 620 and multisignature wallet 624, respectively.

At least one entity member 618 of the entity 614 may confirm and/or approve the transfer request 646 utilizing the entity keypair 642 to sign off on the transaction 628 of the transfer request 646. The entity 614 may communicate a confirmation 632 to the owners of the multisignature wallets of the user account 602 and the user account 604, as well as the block submission service 612 after approving. The user account 602 and the user account 604 may communicate confirmations (confirmation 636 and confirmation 634) to the block submission service 612 from their accounts awaiting approval from the entity 614 and the board authority 616.

In the share tracking system 600, at least one board member 622, depending on the configuration of the board authority 616, receives the transfer request 646 and decides against the share transfer between the user account 602 and the user account 604, and does sign off with their board authority keypair 644. The board authority 616 may then communicate a rejection 630 to the owners of the multisignature wallets of the entity 614, the user account 602, and the user account 604, as well as the block submission service 612.

Although confirmations were received from the entity 614, the user account 602, and the user account 604, the share transfer is configured with a 2/3 vote requiring both the entity 614 and the board authority 616 to approve of a transfer. As the board authority 616 rejected the share transfer between the user account 602 and the user account 604, the block submission service 612 does not generate a share transfer record for the distributed ledger 606

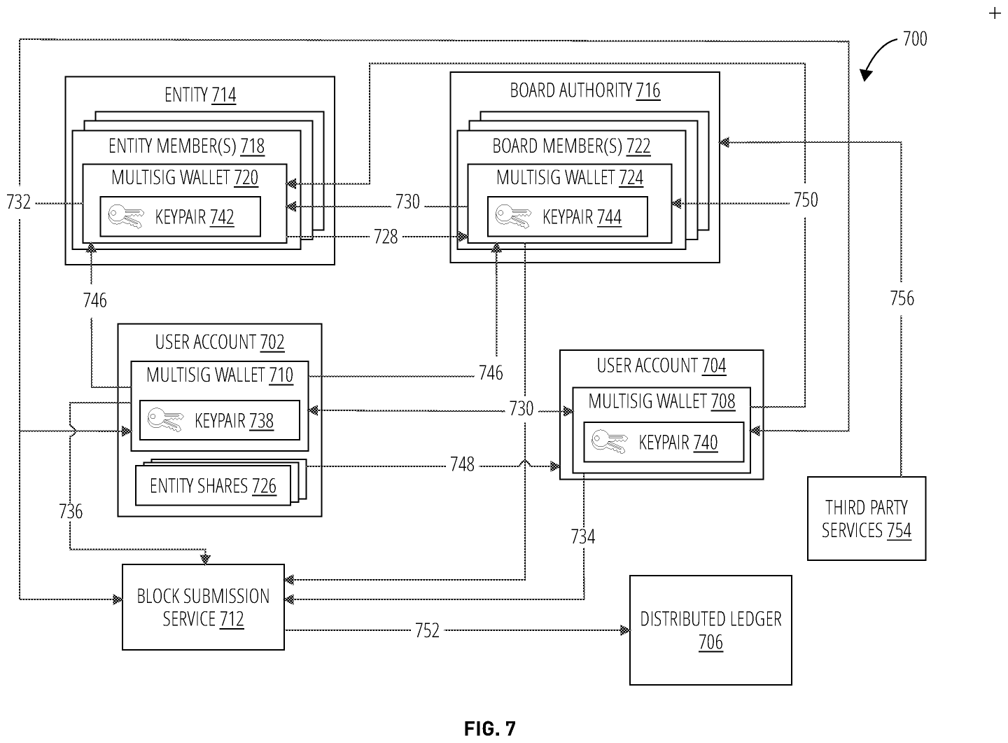

FIG. 7 illustrates a share tracking system 700 in accordance with one embodiment. The share tracking system 700 comprises a block submission service 712, a distributed ledger 706, an entity 714, a board authority 716, a user account 702, and a user account 704. In the share tracking system 700, a share configuration control was received for transferring entity shares 726 from the user account 702 to the user account 704. A user account 702, utilizing the multisignature wallet 710 with the keypair 738, declares via an API, a transfer request 746 to the multisignature wallets of the entity 714 and the board authority 716, multisignature wallet 720 and multisignature wallet 724, respectively. Similarly, the user account 704, utilizing the multisignature wallet 708 with the keypair 740, declares via the API, a transfer request 750 to the multisignature wallets of the entity 714 and the board authority 716, multisignature wallet 720 and multisignature wallet 724, respectively.

At least one entity member 718 of the entity 714 confirms and approves the transfer request 746 through utilizing the entity keypair 742 to sign off on the transaction 728 to the transfer request 746. The entity 714 may communicate a confirmation 732 to the owners of the multisignature wallets of the user account 702 and the user account 704, as well as the block submission service 712 following its vote.

At least one board member 722, depending on the configuration of the board authority 716, receives the transfer request 746. The at least one board member 722 may receive additional transfer information 756 from a third party services 754 such as the securities and exchange commission (SEC), CARTA, etc., and review the information before submitting a response. In some configurations, the entity 714 may also receive the transfer information 756 from the third party services 754 before submitting their response. If the at least one board member 722 determines there are no restrictions, it may utilize its board authority keypair 744 to sign off on the share transfer 748 between the user account 702 and the user account 704. The board authority 716 may communicate a confirmation 730 to the owners of the multisignature wallets of the entity 714, the user account 702, and the user account 704, as well as the block submission service 712.

The user account 702 and the user account 704 may communicate confirmations (confirmation 736 and confirmation 734) from their user accounts to the block submission service 712 awaiting approval from the entity 714 and the board authority 716.

With sign offs received from all participants, the block submission service 712 writes a share transfer record 752 to the distributed ledger 706 indicating a share transfer 748 of entity shares 726 from the user account 702 to the user account 704.

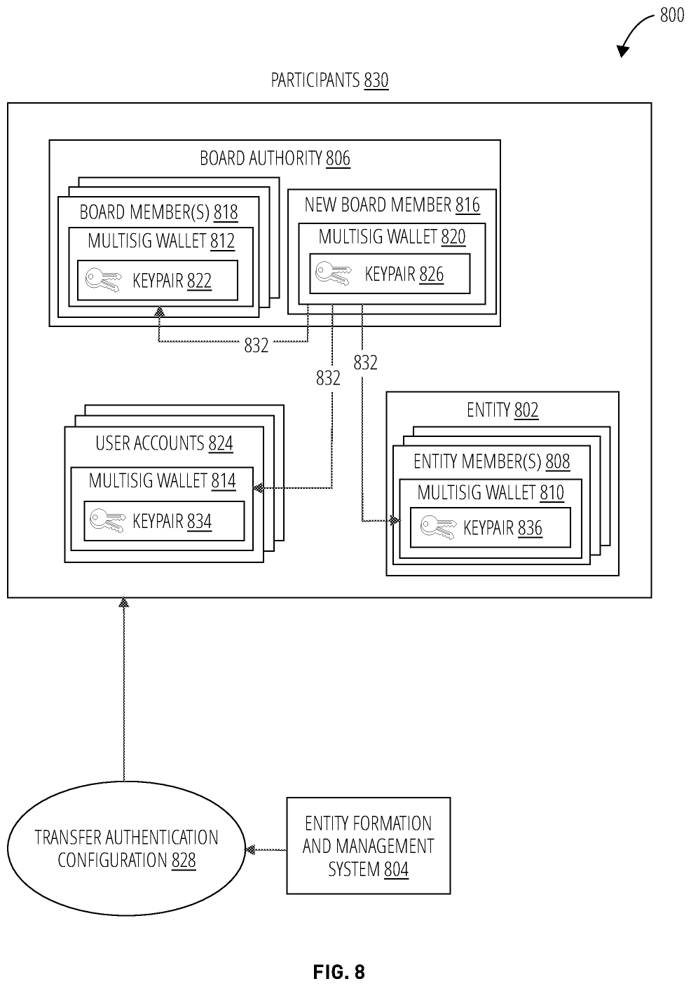

FIG. 8 illustrates a share tracking system 800 in accordance with one embodiment. The share tracking system 800 comprises an entity formation and management system 804 and participants 830 comprising a board authority 806, user accounts 824, and an entity 802. The board authority 806 comprises at least one board member 818 with access to a multisignature wallet 812 comprising a board authority keypair 822. The user accounts 824 comprise a multisignature wallet 814 with a keypair 834. The entity 802 comprises at least one entity member 808 with a multisignature wallet 810 with an entity keypair 836.

A transfer authentication configuration 828 is received from an entity formation and management system 804 configuring the board authority 806 with a new board member 816 comprising a multisignature wallet 820 with a new board authority keypair 826. The addition of the new board member 816 changes the voting requirements for approving transfers as the keypair authentication goes from 2/3 authentication scheme to a 3/4 authentication scheme. As the transfer requirements change with the creation of the new multisignature wallet 820 and new board authority keypair 826, updated transfer requirements 832 are declared from an API, from the multisignature wallet 820 to the multisignature wallets of the at least one board member 818, the user accounts 824, and the entity 802 to ensure that requirements are met before a transfer is process.

In certain embodiments, keypair may not be weighted, however the authentication scheme may be modified to reflect changes in the organization. A common authentication scheme is a 2-of-3 vote authentication; however, there is nothing forbidding organizations from creating our own N-of-M rules, where the N represents the number of keypairs required for vote authentication of a transaction and the M represents the total keypairs in the authentication scheme.

To maintain authority over the share transfer process, the authentication scheme may be modified such that the N keypairs and the M keypair are skewed so that a larger percentage of the M are given to board members and entity shareholders. It may be beneficial to keep the N-keypair number low enough such that it serves its day to day function of approving transfer requests while also having enough keypair votes to represent the opinions of all the board and shareholders.

The authentication scheme may be modified with a longer authentication scheme, for example (1 of user keypair) & (1 of entity keypair) & (1 of board authority keypair) & (1 of board authority keypair) & (1 of board authority keypair). This configuration makes a larger M keypair value and may function similar to a weighted key pair scheme.

Another authentication scheme is to weight the board authority keypairs higher relative to the entity keypairs, for example (1 of user keypair) & (1 of entity keypair+X amount of the total board authority keypairs) & (1 of board authority keypair). In this configuration, some key pairs of the board authority are counted twice to give as part of the entities vote the board a larger say in the decision. This mechanism may be viewed as a weight redistribution but may function to override certain votes from the different keypair groups.

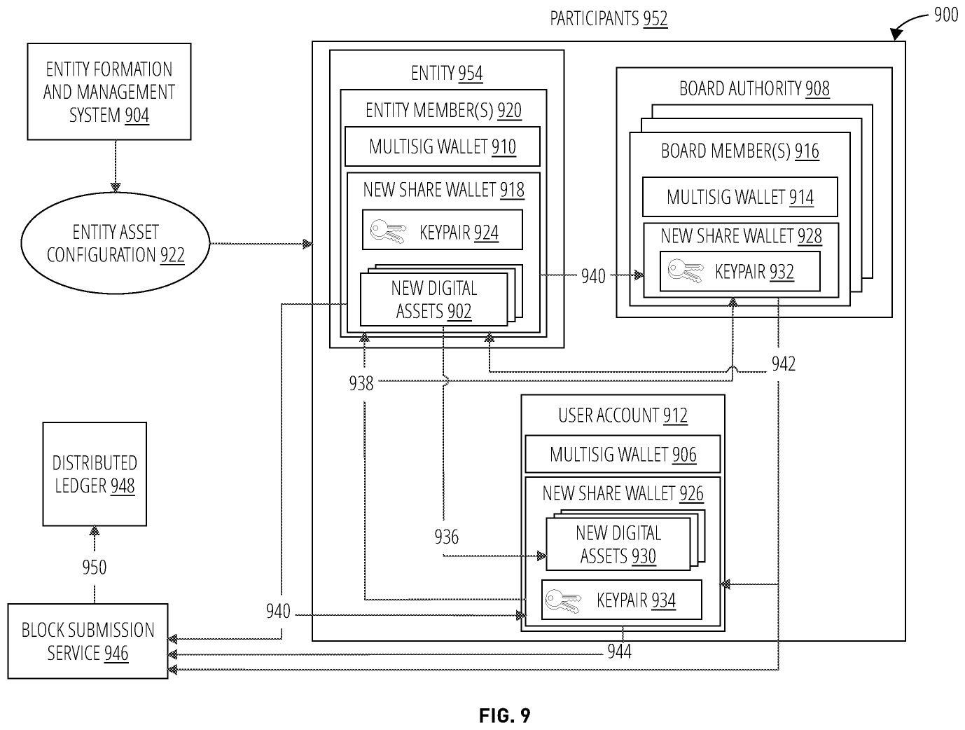

FIG. 9 illustrates a share tracking system 900 in accordance with one embodiment. The share tracking system 900 comprises an entity formation and management system 904, a block submission service 946, a distributed ledger 948, and participants 952 comprising an entity 954, a board authority 908, and a user account 912. The entity 954 comprises at least one entity member 920 with a multisignature wallet 910. The board authority 908 comprises an at least one board member 916 with a multisignature wallet 914. The user account 912 comprises a multisignature wallet 906.

In the share tracking system 900, the participants 952 receive an entity asset configuration 922 from the entity formation and management system 904 that configures the participants 952 with new share multisignature wallets for approving, transferring, and receiving, new digital assets from the entity. The entity 954 receives a new share multisignature wallet 918 with an entity keypair 924. The board authority 908 receives a new share multisignature wallet 928 with a board authority keypair 932. The user account 912 receives a new share multisignature wallet 926 with a user keypair 934.

The entity asset configuration 922 generates new digital assets 902 representing entity shares or new entity shares. The new digital assets 902 may be transferrable to the new share multisignature wallet 926 of a user account 912. In the share tracking system 900, the user account 912 declares via an API a transfer request 938 to the new share multisignature wallets of the entity 954 and the board authority 908. The entity 954 may approve the transfer request 938 and declare via the API a sign off of the transaction 940 from its new share multisignature wallet 918 to the new share multisignature wallet 928 of the board authority 908 and the new share multisignature wallet 926 of the user account 912, as well as the block submission service 946. The board authority 908 may approve the transfer request 938 and declare via the API a sign off of the transaction 942 to the new share multisignature wallet 918 of the entity 954 and the new share multisignature wallet 926 of the user account 912, as well as to the block submission service 946. With approval from the board authority 908 and the entity 954, a new share transfer 936 may be processed such that new digital assets 930 are stored in the new share multisignature wallet 926 of the user account 912. The user account 912 may sign off on the transaction 944 to the block submission service 946. The block submission service 946 may then write a share transfer record 950 to the distributed ledger 948.

In some embodiments, the share tracking system 900 may fill a new share multisignature wallet with new digital assets. The share tracking system 900 may transfer the new digital assets 902 to a first party (user account 912). In this configuration, the new digital assets 902 in the new share multisignature wallet 918 are used to transfer the new issuance entity shares from the new share multisignature wallet 918 to the new share multisignature wallet 926 of the first party. In some instances, the number of new digital assets in the new share multisignature wallet is reduced by the number of new entity shares transferred to the new share multisignature wallet 926. In some instances, the new digital assets are not part of the entity digital assets in the distributed ledger.

In some configurations, the block submission service 946 may update the entity digital assets in the distributed ledger to reflect the new share distribution.

In some configurations, additional share issuances may be handled by minting a larger than necessary number of coins that may be kept in a wallet. The minted coin may not be considered part of the total pool of the entity's shares and may be utilized as a way to send approved transactions from that wallet to another wallet. This transaction represents a new shares issuance event.

In some configurations, the share issuance may be handled by performing a fork to the original blockchain for the transaction records dividing a number of shares past a certain block. In this configuration, the parties may not be able to with keypairs. In this configuration, the creation of the wallet for the user may be done first. After the board and entity send the share, and then the user may be given the key to access their shares.

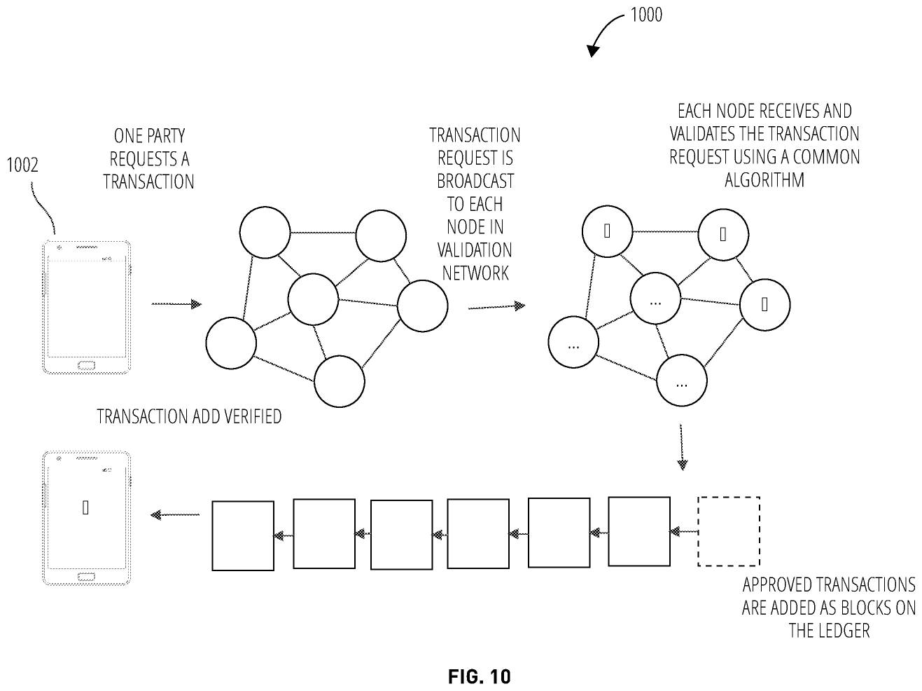

FIG. 10 illustrates a blockchain transaction process 1000 in accordance with one embodiment. A blockchain is an ever-growing set of data blocks. Each block records a collection of transactions. In some configurations, these transactions may come from a transaction requesting device 1002. Blockchains distribute these transactions across a group of computers. Each computer maintains its own copy of the blockchain transactions.

A blockchain is a continuously growing list of records, called blocks, which are linked and secured using cryptography. Each block typically comprises a cryptographic hash of the previous block, a timestamp, and transaction data. By design, a blockchain is resistant to modification of the data. Blockchains may implement an open, distributed ledger that can record transactions between two parties efficiently and in a verifiable and permanent way.

A blockchain is typically managed by multiple parties collectively adhering to a protocol for inter-node communication and validating new blocks. Once recorded, the data in any given block cannot be altered retroactively without alteration of all subsequent blocks, which requires consensus among the operators.

Cryptography involving mathematical methods of keeping data secret and proving identity is utilized when recording transactions. One digital key ensures only an owner can enter a transaction to the blockchain involving their assets, and another digital key lets other parties confirm it really was the owner who added the transaction.

Blockchain is resistant to tampering or other changes by utilizing a cryptographic technique called the hash. Hashing reduces data to a sequence of seemingly random characters—for example, the hash of the phrase “the quick brown fox” is “9ECB36561341D18EB65484E833EFEA61EDC74B84CF5E6AE1B81C63533E25FC8F” using a hash method called SHA-256. Tweaking just one letter in the phrase produces a completely different hash, and you can't go backward to figure out the original data from the hash.

With blockchain, hashes are linked together so any minute change is immediately visible, not just for the block housing it but for all other blocks added later. With red flags that big for changes that small, auditing becomes easier.

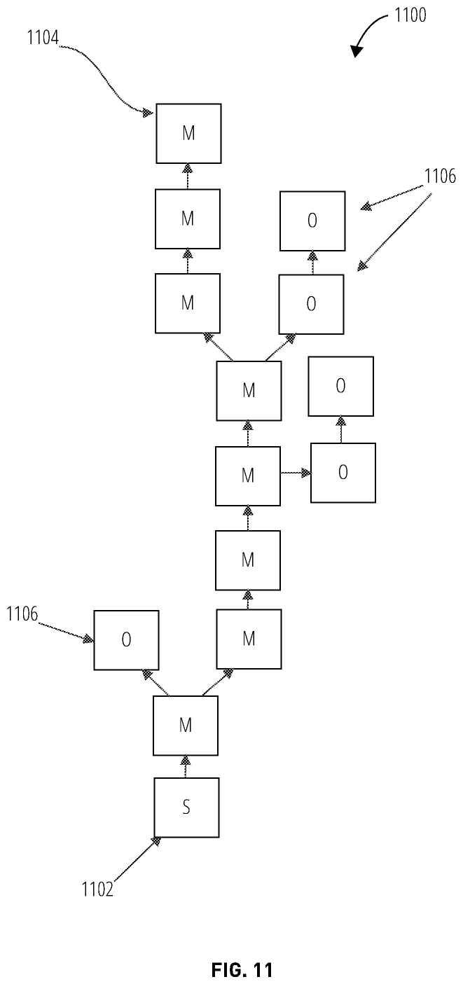

FIG. 11 illustrates an exemplary blockchain formation 1100. The mainchain 1104 (M blocks) comprises the longest series of blocks from the start block 1102 (S block) to the current block. Orphan blocks 1106 (O blocks) exist outside of the main chain.

Blocks hold batches of valid transactions that are hashed and encoded, for example into a Merkle tree. Each block includes the cryptographic hash of the prior block in the blockchain formation 1100, linking the two. The linked blocks form a chain. This iterative process confirms the integrity of the previous block, all the way back to the original start block 1102.

Sometimes separate blocks can be produced concurrently, creating a temporary fork. In addition to a secure hash-based history, the blockchain formation 1100 has a specified algorithm for scoring different versions of the history so that one with a higher value can be selected over others. Blocks not selected for inclusion in the mainchain 1104 are called orphan blocks 1106. Peers supporting the blockchain formation 1100 have different versions of the history from time to time. They keep only the highest-scoring version of the blockchain formation 1100 known to them. Whenever a peer receives a higher-scoring version (usually the old version with a single new block added) they extend or overwrite their local version of the blockchain formation 1100 and retransmit the improvement to their peers. There is never an absolute guarantee that any particular entry will remain in the best version of the history forever. Because blockchains are typically built to add the score of new blocks onto old blocks and because there are incentives to work only on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. There are a number of methods that can be used to demonstrate a sufficient level of computation. Within a blockchain the computation is carried out redundantly rather than in the traditional segregated and parallel manner.

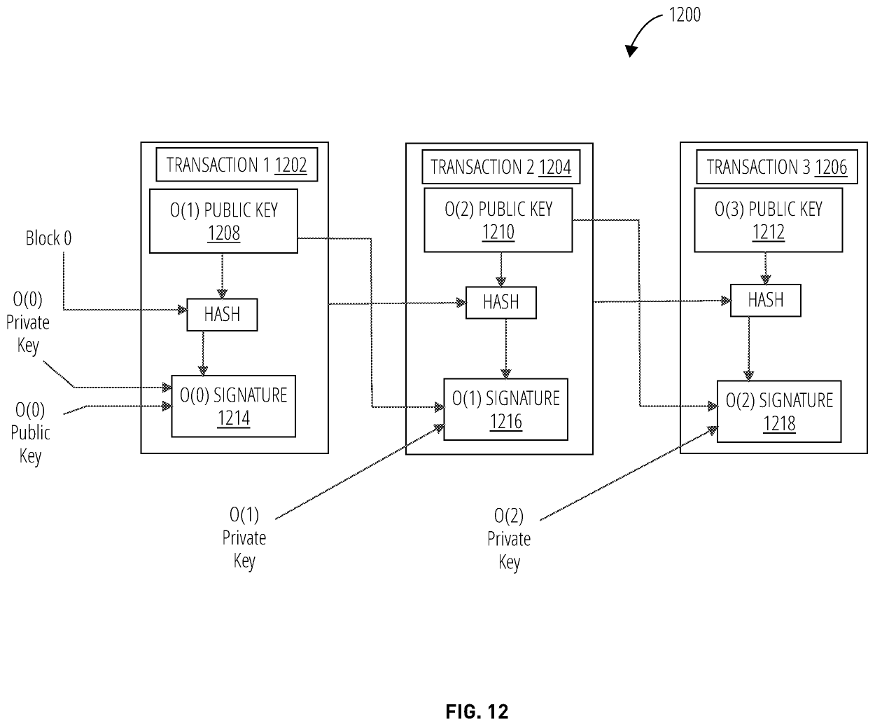

FIG. 12 illustrates an embodiment of an irreversible transaction blockchain 1200. The blockchain 1200 is a sequence of digitally signed transactions (transaction 1 1202, transaction 2 1204, and transaction 3 1206 etc.). Each transaction includes the current owners public key (block 1 owner public key 1208, block 2 owner public key 1210, and block 3 owner public key 1212 respectively) and the previous owner's signature (O(0) signature 1214, O(1) signature 1216, and O(2) signature 1218) which are generated using a hash function. The owner of a transaction can examine each previous transaction to verify the chain of ownership. Unlike traditional check endorsements, the transactions in the blockchain 1200 are irreversible, which mitigates fraud.

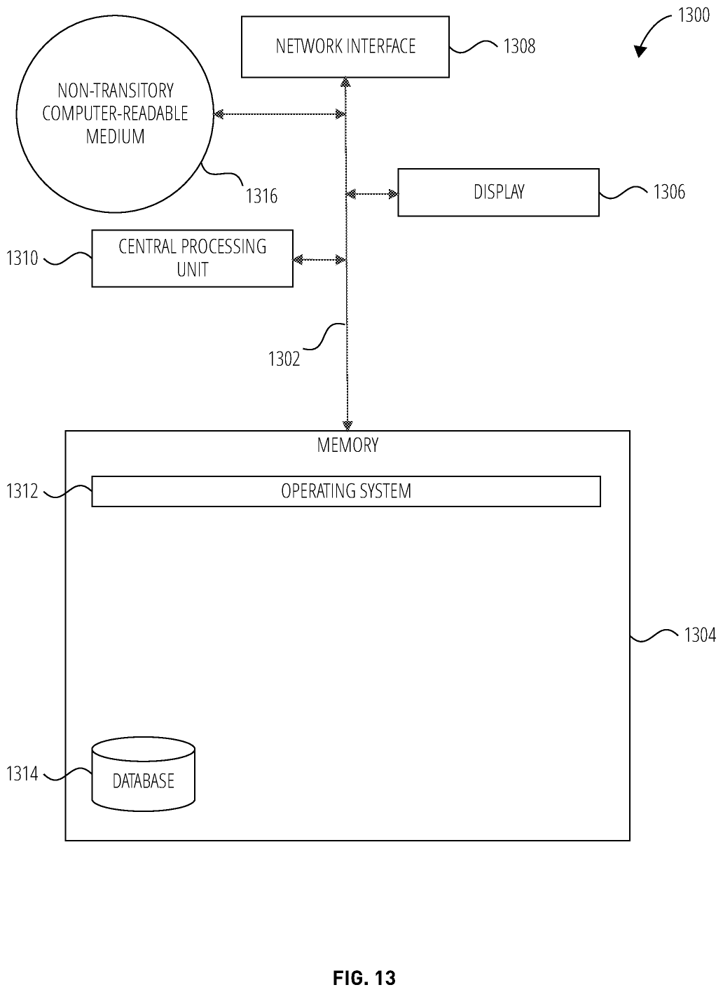

FIG. 13 illustrates several components of an exemplary system 1300 in accordance with one embodiment. In various embodiments, system 1300 may include a desktop PC, server, workstation, mobile phone, laptop, tablet, set-top box, appliance, or other computing device that is capable of performing operations such as those described herein. In some embodiments, system 1300 may include many more components than those shown in FIG. 13. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 1300 may comprise one or more physical and/or logical devices that collectively provide the functionalities described herein. In some embodiments, system 1300 may comprise one or more replicated and/or distributed physical or logical devices.

In some embodiments, system 1300 may comprise one or more computing resources provisioned from a “cloud computing” provider, for example, Amazon Elastic Compute Cloud (“Amazon EC2”), provided by Amazon.com, Inc. of Seattle, Washington; Sun Cloud Compute Utility, provided by Sun Microsystems, Inc. of Santa Clara, Calif.; Windows Azure, provided by Microsoft Corporation of Redmond, Wash., and the like.

System 1300 includes a bus 1302 interconnecting several components including a network interface 1308, a display 1306, a central processing unit 1310, and a memory 1304.

Memory 1304 generally comprises a random access memory (“RAM”) and permanent non-transitory mass storage device, such as a hard disk drive or solid-state drive. Memory 1304 stores an operating system 1312.

These and other software components may be loaded into memory 1304 of system 1300 using a drive mechanism (not shown) associated with a non-transitory computer-readable medium 1316, such as a DVD/CD-ROM drive, memory card, network download, or the like.

Memory 1304 also includes database 1314. In some embodiments, system 1300 may communicate with database 1314 via network interface 1308, a storage area network (“SAN”), a high-speed serial bus, and/or via the other suitable communication technology.

In some embodiments, database 1314 may comprise one or more storage resources provisioned from a “cloud storage” provider, for example, Amazon Simple Storage service (“Amazon S3”), provided by Amazon.com, Inc. of Seattle, Wash., Google Cloud Storage, provided by Google, Inc. of Mountain View, Calif., and the like.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

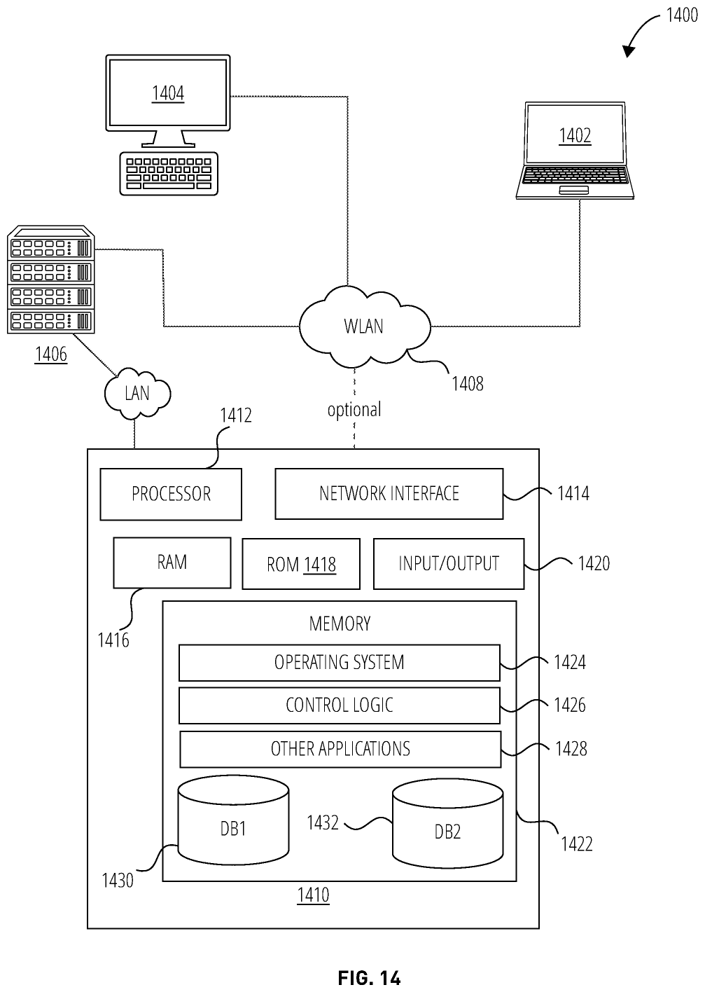

FIG. 14 illustrates one example of a system architecture and data processing device that may be used to implement one or more illustrative aspects described herein in a standalone and/or networked environment. Various network nodes including data server 1410, web server 1406, computer 1404, and laptop 1402 may be interconnected via a wide area network 1408 (WAN), such as the internet. Other networks may also or alternatively be used, including private intranets, corporate networks, LANs, metropolitan area networks (MANs) wireless networks, personal networks (PANs), and the like. Network 1408 is for illustration purposes and may be replaced with fewer or additional computer networks. A local area network (LAN) may have one or more of any known LAN topology and may use one or more of a variety of different protocols, such as ethernet. Devices including data server 1410, web server 1406, computer 1404, laptop 1402 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components in the illustrative computer system architecture 1400 may include data server 1410, web server 1406, and client computer 1404, laptop 1402. Data server 1410 provides overall access, control and administration of databases and control software for performing one or more illustrative aspects described herein. Data server 1410 may be connected to web server 1406 through which users interact with and obtain data as requested. Alternatively, data server 1410 may act as a web server itself and be directly connected to the internet. Data server 1410 may be connected to web server 1406 through the network 1408 (e.g., the internet), via direct or indirect connection, or via some other network. Users may interact with the data server 1410 using remote computer 1404, laptop 1402, e.g., using a web browser to connect to the data server 1410 via one or more externally exposed web sites hosted by web server 1406. Client computer 1404, laptop 1402 may be used in concert with data server 1410 to access data stored therein, or may be used for other purposes. For example, from client computer 1404, a user may access web server 1406 using an internet browser, as is known in the art, or by executing a software application that communicates with web server 1406 and/or data server 1410 over a computer network (such as the internet).

Servers and applications may be combined on the same physical machines, and retain separate virtual or logical addresses, or may reside on separate physical machines. FIG. 14 illustrates just one example of a network architecture that may be used, and those of skill in the art will appreciate that the specific network architecture and data processing devices used may vary, and are secondary to the functionality that they provide, as further described herein. For example, services provided by web server 1406 and data server 1410 may be combined on a single server.

Each component including data server 1410, web server 1406, computer 1404, laptop 1402 may be any type of known computer, server, or data processing device. Data server 1410, e.g., may include a processor 1412 controlling overall operation of the data server 1410. Data server 1410 may further include RAM 1416, ROM 1418, network interface 1414, input/output interfaces 1420 (e.g., keyboard, mouse, display, printer, etc.), and memory 1422. Input/output interfaces 1420 may include a variety of interface units and drives for reading, writing, displaying, and/or printing data or files. Memory 1422 may further store operating system software 1424 for controlling overall operation of the data server 1410, control logic 1426 for instructing data server 1410 to perform aspects described herein, and other application software 1428 providing secondary, support, and/or other functionality which may or may not be used in conjunction with aspects described herein. The control logic may also be referred to herein as the data server software control logic 1426. Functionality of the data server software may refer to operations or decisions made automatically based on rules coded into the control logic, made manually by a user providing input into the system, and/or a combination of automatic processing based on user input (e.g., queries, data updates, etc.).

Memory 1422 may also store data used in performance of one or more aspects described herein, including a first database 1432 and a second database 1430. In some embodiments, the first database may include the second database (e.g., as a separate table, report, etc.). That is, the information can be stored in a single database, or separated into different logical, virtual, or physical databases, depending on system design. Web server 1406, computer 1404, laptop 1402 may have similar or different architecture as described with respect to data server 1410. Those of skill in the art will appreciate that the functionality of data server 1410 (or web server 1406, computer 1404, laptop 1402) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

1-20. (canceled)

21. A system comprising:
a blockchain ledger;
at least one processor;
a machine-readable medium comprising:
a first component structure comprising at least one first digital wallet;
a second component structure comprising a plurality of second digital wallets;
a third component structure comprising a third digital wallet;
the first component structure, the second component structure, and the third component structure configured to have a common affiliation;
each of the first digital wallet and the second digital wallet configured with N/M authentication capability for a transfer of a digital asset to the third digital wallet, where N<=M, such that at least N key pairs out of M are required to authorize the transfer of the digital asset;
instructions that when executed by the processor effect the digital asset transfer by:
communicating a transfer request for the digital asset from the third component structure to the first component structure and to the second component structure;
communicating an approval request for the transfer request from the first component structure to the second component structure;
applying a smart contract encoded on the blockchain to authorize the transfer request at the second component structure;
generating a first authorization of the transfer request at the second component structure by way of a key pair providing the N/M authentication of the second digital wallet;
communicating the first authorization of the transfer request from the second component structure to the first component structure and to the third component structure;
applying the first authorization and the smart contract encoded on the blockchain to authorize the transfer request at the first component;
generating a second authorization of the transfer request at the first component structure by way of a key pair providing the N/M authentication of the first digital wallet;
communicating the second authorization of the transfer request from the first component structure to the third component structure;
generating a third authorization of the transfer request at the third component structure by way of a key pair of the third digital wallet;
communicating the first authorization, the second authorization, and the third authorization of the transfer request to a block submission service to generate an asset transfer record for the blockchain ledger;
communicating the asset transfer record to an oracle service that is not configured with the common affiliation;
applying the smart contract encoded on the blockchain to verify the transfer request at the oracle service;
modifying the blockchain ledger with at least one block representing the asset transfer record upon verification of the asset transfer record by the oracle service; and
upon modifying the blockchain ledger with the block representing the asset transfer record, moving the digital asset from the first digital wallet to the third digital wallet.

22. The computer system of claim 21, wherein the system is further configured to effect a transfer of the digital asset by:
generating the first authorization of the transfer request at the second component structure by way of multiple weighted key pairs that in aggregate provide the N/M authentication of the second digital wallet.

23. The computer system of claim 22, wherein the system is further configured to effect a transfer of the digital asset by:
generating the second authorization of the transfer request at the first component structure by way of multiple weighted key pairs that in aggregate provide the N/M authentication of the first digital wallet.
